(19) United States
(12) Patent Application Publication
(10) Pub. No.: US 2025/0339941 A1
(43) Pub. Date: Nov. 6, 2025

(54) Machine and method for running a machine

(71) Applicant: Hilti Aktiengesellschaft, Schaan (LI)

(72) Inventors: Andreas WETTSTEIN, Feldkirch (AT); Pauric DOHERTY, Zurich (CH); Pablo NIESUTTA, Buchs (CH)

(21) Appl. No.: 18/870,830

(22) PCT Filed: Jun. 13, 2023
(86) PCT No.: PCT/EP2023/065800

§ 371 Date: Dec. 2, 2024

(30) Foreign Application Priority Data
Jun. 28, 2022 (EP) 22181518.6

(51) Int. Cl. B25B 23/147; B25B 23/00

(52) U.S. Cl. CPC B25B 23/147; B25B 23/0064

(57) ABSTRACT

A machine and a method for setting a screw, wherein the machine includes a motor having a shaft, and a controller provided for providing electric current to the motor to rotationally drive the shaft, continuously determining a first parameter characterizing a setting process, recognizing a thread-engagement start time if the first parameter meets a predefined set of conditions, determining a second parameter affecting a time difference between the recognized thread-engagement start time and a real thread-engagement start time, calculating a target number of rotations to be performed by the motor after the recognized thread-engagement start time in dependence on the second parameter, and stopping the motor when the motor has performed the target number of rotations after the recognized thread-engagement start time.

### TECHNICAL FIELD

Described herein are machines and methods for running the machines to set screws. Also described are hand-held power tools for enabling screw-setting actions. Typically, such hand-held tools find a widespread use in the construction industry. A typical hand-held tool as intended to be covered by the scope of the present invention includes, but is not limited to, an automatic screw driver for screwing screw fasteners into a workpiece, thereby penetrating the workpiece, such as a metal plate, with a screw fastener.

### BACKGROUND ART

Hand-held power tools are known to enable setting actions of a screw. The tools comprise at least a machine housing including at least a motor that provides at least rotary motion to a rotary shaft. The rotary shaft, in turn, will ultimately transmit a certain torque at a certain rotational speed to a workpiece penetrating element, such as, for example, a drill or a screw fastener. A tool may also comprise a controller, for controlling the motor and continuously determining several parameters of the drilling or setting process, such as the delivered torque and rotational speed of the rotary shaft when the tool is in use.

### SUMMARY OF THE INVENTION

One possible field of application is setting self-tapping and self-sealing threaded fasteners into predrilled holes. A sealing performance may depend on a setting depth of the fastener into the predrilled hole. Such work is usually done using a depth gauge which needs to be calibrated under certain circumstances which may be cumbersome and/or time-consuming.

According to one aspect, a method for running a machine to set a screw along a setting axis into a workpiece, wherein the machine comprises a motor having a shaft, comprises providing electric current to the motor to rotationally drive the shaft, continuously determining a first parameter characterizing a setting process, recognizing a thread-engagement start time if the first parameter meets a predefined set of conditions, determining a second parameter affecting a time difference between the recognized thread-engagement start time and a real thread-engagement start time, calculating a target number of rotations to be performed by the motor after the recognized thread-engagement start time in dependence on the second parameter, and stopping the motor when the motor has performed the target number of rotations after the recognized thread-engagement start time.

According to another aspect, a machine for drilling a hole and/or setting a screw along a setting axis into a workpiece comprises a motor having a shaft, a switch, and a controller provided for providing electric current to the motor to rotationally drive the shaft, continuously determining a first parameter characterizing a setting process, recognizing a thread-engagement start time if the first parameter meets a predefined set of conditions, determining, or continuously determining, a second parameter affecting a time difference between the recognized thread-engagement start time and a real thread-engagement start time, calculating a target number of rotations to be performed by the motor after the recognized thread-engagement start time in dependence on the second parameter, and stopping the motor when the motor has performed the target number of rotations after the recognized thread-engagement start time.

According to an embodiment, the first parameter comprises at least one of a voltage of the electric current provided to the motor, an amperage of the electric current provided to the motor, a power consumption of the electric current provided to the motor, a rotational speed of the motor, a change thereof over time, and a combination thereof.

In a preferred embodiment, determining the second parameter is performed before the recognized thread-engagement start time. In an alternative or additional embodiment, determining the second parameter is performed after the recognized thread-engagement start time.

According to another embodiment, the second parameter comprises at least one of a force towards the machine along the setting axis applied to the shaft, a torque around the setting axis applied to the shaft, a voltage of the electric current provided to the motor, an amperage of the electric current provided to the motor, a power consumption of the electric current provided to the motor, a rotational speed of the motor, an acceleration of the machine along the setting axis, an acceleration of the machine across the setting axis, a rotation of the machine around the setting axis, a yaw rate of the machine, a temperature of the machine, a change thereof over time, and a combination thereof.

### BRIEF DESCRIPTION OF THE DRAWINGS

Further aspects and advantages of the machine, associated parts and a method of use thereof will become apparent from the ensuing description that is given by way of example only and with reference to the accompanying drawings in which:

FIG. 1 shows a machine for drilling holes and setting screws.

### DETAILED DESCRIPTION

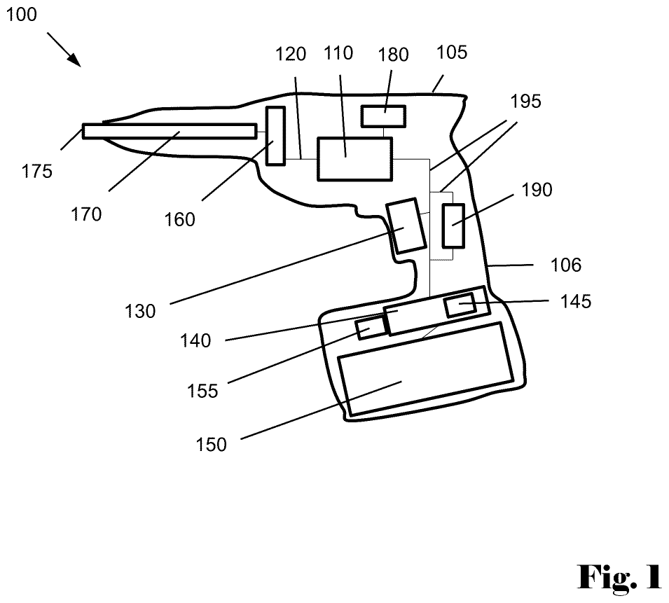

FIG. 1 shows a machine 100 for drilling a hole and/or setting a screw. In the embodiment shown, the machine 100 is formed as a hand-held working tool such as an automatic screwdriver. The machine 100 comprises a housing 105 and, enclosed by the housing 105, a motor 110 having a shaft 120, a switch 130 formed as a trigger switch, a controller 140 formed as a microcomputer and having a data storage 145 formed as a computer memory, a battery 150, and a communication unit 155 formed as a wireless transmitter. The controller 140 provides electric current from the battery 150 to the motor 110 to rotationally drive the shaft 120. The machine 100 further comprises a gear 160 and a spindle 170 having a screw drive 175 such as a hex drive and driven by the shaft 120 via the gear 160.

Further, the machine 100 comprises a rotational-speed sensor 180 for detecting a rotational speed of the motor 110 and an amperage/voltage sensor 190 for detecting an amperage and/or voltage of the electric current provided to the motor 110. Further, the machine 100 comprises several acceleration sensors for detecting a force towards the machine along the setting axis applied to the shaft, an acceleration of the machine along the setting axis, an acceleration of the machine across the setting axis, a rotation of the machine around the setting axis, and a yaw rate of the machine, i.e. a rotation of the machine around an axis perpendicular to the setting axis.

Further, the machine 100 comprises lines 195 which connect the controller 140 with the motor 110, the switch 130 and sensors 180, 190 for transmitting electric current to the motor 110 and/or collecting electric signals from the switch 130 and/or sensors 180, 190. Additionally, or alternatively, to acquire data on the rotational speed, amperage or voltage of the motor 110, the controller 140 may use information already present from its controlling a rotational movement of the motor 110, for example the number of electrical commutations over time for the rotational speed. The housing 105 comprises a grip section 106 for manually gripping the machine 100 by a user such that the switch 130 can be pressed by the user's index finger. The switch 130 is capable of signaling its switch position to the controller 140 via the lines 195.

In use, the machine 100 can be set-up by choosing the right clutch setting and gear, which activate e.g. a specific screw fastening mode. During the fastening process, the controller 140 monitors several parameters, such as the voltage, amperage and power consumption of the electric current provided to the motor, a rotational speed of the motor, a force towards the machine along the setting axis applied to the shaft, a torque around the setting axis applied to the shaft, an acceleration of the machine along the setting axis, an acceleration of the machine across the setting axis, a rotation of the machine around the setting axis, a yaw rate of the machine, and a temperature of the machine. Further, the controller 140 monitors a change of these parameters over time.

The controller 140 recognizes a thread-engagement start time if a first parameter, such as e.g. the power consumption of the electric current provided to the motor, meets a predefined set of conditions, such as e.g. a local minimum in time after a ramp-up phase of the machine followed by a rise. The controller 140 then calculates a target number of rotations to be performed by the motor after the recognized thread-engagement start time in order to complete the screw setting process at the right point, and stops the motor when the motor has performed the target number of rotations after the recognized thread-engagement start time. However, the recognized thread-engagement start time may not exactly correspond to a real thread-engagement start time. In order to compensate for a time difference between the recognized thread-engagement start time and a real thread-engagement start time, the controller 140 considers one or more second parameters which may affect the time difference mentioned above when calculating the target number of rotations. To this end, a non-linear model equation derived by using well-known statistical methods during development or testing of the machine may be used. The controller 140 may determine the second parameter before and/or after the recognized thread-engagement start time.

In summary, when the thread of the screw engages ans starts tapping in a hole of a substructure, the controller 140 recognizes a specific behavior of some parameters affecting a time difference between the recognized thread-engagement start time and a real thread-engagement start time. The controller then stops the motor after a target number of rotations. The screw fastening process is reliably stopped at the right point, thus providing e.g. a more accurate compression of a sealing element.

Throughout the present application, “current provided to the motor” is meant to include current that is measured within a power supply, such as a battery, if the hand-held power tool is a battery-operated tool.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. The functionality described may be distributed among modules that differ in number and distribution of functionality from those described herein. Additionally, the order of execution of the functions may be changed depending on the embodiment. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

1-12. (canceled)

13. A method for running a machine to set a screw along a setting axis into a workpiece, wherein the machine comprises a motor having a shaft, the method comprising:
providing electric current to the motor to rotationally drive the shaft;
continuously determining a first parameter characterizing a setting process;
recognizing a thread-engagement start time if the first parameter meets a predefined set of conditions;
determining a second parameter affecting a time difference between the recognized thread-engagement start time and a real thread-engagement start time;
calculating a target number of rotations to be performed by the motor after the recognized thread-engagement start time in dependence on the second parameter; and
stopping the motor when the motor has performed the target number of rotations after the recognized thread-engagement start time.

14. The method as recited in claim 13 wherein the first parameter includes at least one of a voltage of the electric current provided to the motor, an amperage of the electric current provided to the motor, a power consumption of the electric current provided to the motor, a rotational speed of the motor, a change thereof over time, and a combination thereof.

15. The method as recited in claim 13 wherein determining the second parameter includes continuously determining the second parameter.

16. The method as recited in claim 13 wherein determining the second parameter is performed before the recognized thread-engagement start time.

17. The method as recited in claim 13 wherein determining the second parameter is performed after the recognized thread-engagement start time.

18. The method as recited in claim 13 wherein the second parameter includes at least one of a force towards the machine along the setting axis applied to the shaft, a torque around the setting axis applied to the shaft, a voltage of the electric current provided to the motor, an amperage of the electric current provided to the motor, a power consumption of the electric current provided to the motor, a rotational speed of the motor, an acceleration of the machine along the setting axis, an acceleration of the machine across the setting axis, a rotation of the machine around the setting axis, a yaw rate of the machine, a temperature of the machine, a change thereof over time, and a combination thereof.

19. A machine for drilling a hole and/or setting a screw along a setting axis into a workpiece, the machine comprising:
a motor having a shaft;
a switch; and
a controller provided for providing electric current to the motor to rotationally drive the shaft, continuously determining a first parameter characterizing a setting process, recognizing a thread-engagement start time if the first parameter meets a predefined set of conditions, determining a second parameter affecting a time difference between the recognized thread-engagement start time and a real thread-engagement start time, calculating a target number of rotations to be performed by the motor after the recognized thread-engagement start time in dependence on the second parameter, and stopping the motor when the motor has performed the target number of rotations after the recognized thread-engagement start time.

20. The machine as recited in claim 19 wherein the first parameter includes at least one of a voltage of the electric current provided to the motor, an amperage of the electric current provided to the motor, a power consumption of the electric current provided to the motor, a rotational speed of the motor, a change thereof over time, and a combination thereof.

21. The machine as recited in claim 19 wherein the controller is provided for continuously determining the second parameter.

22. The machine as recited in claim 19 wherein the controller is provided for determining the second parameter before the recognized thread-engagement start time.

23. The machine as recited in claim 19 wherein the controller is provided for determining the second parameter after the recognized thread-engagement start time.

24. The machine as recited in claim 19 wherein the second parameter includes at least one of a force towards the machine along the setting axis applied to the shaft, a torque around the setting axis applied to the shaft, a voltage of the electric current provided to the motor, an amperage of the electric current provided to the motor, a power consumption of the electric current provided to the motor, a rotational speed of the motor, an acceleration of the machine along the setting axis, an acceleration of the machine across the setting axis, a rotation of the machine around the setting axis, a yaw rate of the machine, a temperature of the machine, a change thereof over time, and a combination thereof.
